(19) United States
(12) Patent Application Publication
(10) Pub. No.: US 2012/0094021 A1
(43) Pub. Date: Apr. 19, 2012

(54) METHOD OF FORMING A DIFFUSION ALUMINIDE COATING ON A SURFACE OF A TURBINE COMPONENT AND A HOMOGENEOUS PASTE FOR COATING SUCH SURFACES

(75) Inventors: William Paul MacGregor, Simpsonville, SC (US); Michael Ralph Rossello, Simpsonville, SC (US); Robert James Van Cleaf, Greenwood, SC (US)

(73) Assignee: Goodrich Corporation, Charlotte, NC (US)

(21) Appl. No.: 13/267,281

(22) Filed: Oct. 6, 2011

Related U.S. Application Data
(60) Provisional application No. 61/404,981, filed on Oct. 13, 2010.

(51) Int. Cl. B05D 5/00; C09D 101/02; C09D 191/00; B05C 11/10; B05D 3/00; B05D 3/02; B05C 5/00; B05C 11/00; C09D 1/00; B05D 7/22

(52) U.S. Cl. 427/230; 106/287.17; 106/204.01; 106/285; 106/287.26; 106/287.27; 427/372.2; 427/299; 118/300; 118/317; 118/612

(57) ABSTRACT

The subject invention is directed to diffusion aluminide coatings, and more particularly, to a homogenous paste for applying a diffusion aluminide coating to a selected surface of a turbine component and to a method of applying a diffusion aluminide coating to a selected surface of a turbine component.

### CROSS REFERENCE TO RELATED APPLICATIONS

This application claims the benefit of priority of U.S. Provisional Application No. 61/404,981, filed Oct. 13, 2010, the disclosure of which is expressly incorporated herein by reference in its entirety.

### BACKGROUND OF THE INVENTION

1. Field of the Invention

The subject invention is directed generally to diffusion aluminide coatings, and more particularly, to a homogenous paste for applying a diffusion aluminide coating to a selected surface of a turbine component and to a method of applying a diffusion aluminide coating to a selected surface of a turbine component.

2. Background of the Related Art

In gas turbine engines, the vanes, buckets and blades are typically made of nickel-based superalloys that operate at temperatures reaching 1800-2100° F. Many approaches have been used to increase the operating temperature limit of these turbine components. In one approach, internal cooling passages are formed within the interior of the turbine component. Air is forced through the cooling passages and out openings at the external surface of the component, removing heat from the interior of the component. The surfaces of the internal cooling passages are often provided with a protective coating. Aluminide diffusion coatings are commonly used for this purpose.

Those skilled in the art will readily appreciate that the internal surfaces of a turbine component are subjected to a significantly different service environment than the external surfaces of the component. The external surfaces experience hot corrosion, hot oxidation, and erosion in the combustion gas. In order to cool the operating temperature of the component, a flow of bleed air from the engine compressor, (not combustion gas), is passed through the internal passages. This assures the internal surfaces are at a lower temperature than the external surfaces. In some operating conditions, the cooling air may contain salt, sulfur, and other contaminants. The presence of salt and sulfur at a temperature in the range of about 1300° F., a typical temperature for the internal surfaces, may lead to severe hot corrosion on the internal surfaces. The internal surfaces of the gas turbine components are thus subjected to environmental damage of a type substantially different from that experienced on the external surfaces of a turbine component.

The protection of the internal surfaces poses a substantially different problem than the protection of the external surfaces of the gas turbine component. The internal surfaces are usually formed by small internal passages, that are typically from about 0.1 inch to about 0.5 inch in diameter, and they are not readily accessible to many conventional exterior surface coating techniques. Consequently, the protective layer on the internal surfaces cannot be readily repaired, and therefore must last longer than the protective layer on the external surfaces, which can be more readily refurbished. Current techniques for coating the interior surfaces of a turbine component include pack cementation, vapor phase, and slurry coating processes. Pack cementation produces an adequate coating, but it is a costly, time consuming process. Slurry coating often produce a discontinuous coating with saw-toothed surface structures. Neither process is optimal. Vapor phase coatings can produce good coatings but the coating systems and tooling required high maintenance and are typically more expensive.

Thus, there is a need for improved, low cost, coating methods for protecting the internal surfaces of turbine components. The present invention fulfills this need, and further provides related advantages.

### SUMMARY OF THE INVENTION

The subject invention is directed to a new and useful homogenous paste for forming a protective coating on a substrate surface. In certain embodiments, the paste is useful for coating the internal surfaces of an article having internal and external surfaces. In particular embodiments, the paste is useful for coating the internal surfaces of interior cooling passages of a turbine component. In certain other embodiments, the paste may be useful for coating external surfaces as needed to meet component design requirements.

In one aspect, the invention provides a homogenous coating paste for forming a protective coating on a substrate surface, comprising:

a) a metallic base component; and

b) an organic binder;

wherein said metallic base component comprises:
i) a metallic aluminum alloy;
ii) a halide activator; and
iii) an inert filler.

In some embodiments, the metallic aluminum alloy of the coating paste comprises a cobalt group metal. In particular embodiments, the metallic aluminum alloy is Co₂Al₉.

In still other embodiments, the halide activator of the coating paste is a non-hygroscopic halide activator. In particular embodiments, the halide activator of the coating paste is ammonium chloride, ammonium iodide, ammonium bromide, ammonium fluoride, ammonium bifluoride, elemental iodine, elemental bromine, hydrogen bromide, aluminum chloride, aluminum fluoride, aluminum bromide, or aluminum iodide. In specific embodiments, the halide activator of the coating paste is AlF₃.

In certain embodiments, the homogenous coating paste of the invention further comprises an organic binder, an inert filler or a combination thereof. In such embodiments, the organic binder comprises methyl cellulose and de-ionized water; hydroxypropylcellulose; a petroleum-based binder; a solvent-based binder; an alcohol-based binder; a water-based organic polymer; or combinations thereof. In particular embodiments, the organic binder comprises methyl cellulose and de-ionized water. Similarly, in such embodiments, the inert filler is aluminum oxide (Al₂O₃), kaolin, MgO, SiO₂, Y₂O₃ or Cr₂O₃. In particular embodiments, the inert filler is Al₂O₃.

In yet other embodiments, the ratio of metallic base component to organic binder in the homogenous coating paste of the invention is from about 10:1 to about 1:10, from about 5:1 to about 1:5, or from about 2:1 to about 1:2. In another embodiment, the ratio of metallic base component to organic binder in the homogenous coating paste of the invention is about 1:1.

In still other embodiments, the homogenous coating paste of the invention comprises metallic aluminum alloy from about 1% to about 50% by weight of the total metallic base component, from about 3% to about 40% by weight of the total metallic base component, or from about 5% to about 30% by weight of the total metallic base component.

In yet other embodiments, the homogenous coating paste of the invention comprises halide activator from about 0.1% to about 5.0% by weight of the total metallic base component, from about 0.5% to about 4.0% by weight of the total metallic base component, or from about 1% to about 3% by weight of the total metallic base component.

In particular embodiments, the homogenous coating paste of the invention comprises metallic aluminum alloy is from about 1% to about 50% by weight of the total metallic base component and halide activator is from about 0.1% to about 5.0% by weight of the total metallic base component, metallic aluminum alloy from about 3% to about 40% by weight of the total metallic base component and halide activator from about 0.5% to about 4.0% by weight of the total metallic base component, or metallic aluminum alloy from about 5% to about 30% by weight of the total metallic base component and halide activator is from about 1% to about 3% by weight of the total metallic base component.

In another aspect, the subject invention is also directed to a new and useful method of applying a protective coating on the internal surfaces of an article having internal and external surfaces. In particular embodiments, the subject invention is directed to a new and useful method of applying a protective coating on the internal surfaces of the cooling passages of a turbine component, which includes the steps of injecting a coating paste into the cooling passages of the turbine component, curing the coating paste in a temperature range of about 150° F. to 200° F. to stabilize the material, and then heating the turbine component in a furnace within a predetermined temperature range of about between 1500° F. and 2000° F. for a sufficient time period to obtain a desired aluminide coating on the internal surfaces of the cooling passages. The method further includes the step of removing any residual paste from the cooling passages after it is removed from the furnace. This may be done using air or fluid.

In certain embodiments, the method further includes the steps of heat treating the turbine component to produce a desired coating thickness and microstructure, and finishing the turbine component to obtain a desired surface appearance. It is envisioned that the internal surfaces of the cooling passages can be treated or otherwise prepared before injecting the paste into said passages to enhance coating adhesion.

In another aspect, the subject invention is also directed to a new and useful method of applying a protective coating on the external surface of an article, which includes the steps of applying a coating paste into the external surface of the article, curing the coating paste in a temperature range of about 150° F. to 200° F. to stabilize the material, and then heating the article in a furnace within a predetermined temperature range of about between 1500° F. and 2000° F. for a sufficient time period to obtain a desired aluminide coating on the internal surfaces of the cooling passages. The method further includes the step of removing any residual paste from the article after it is removed from the furnace. This may be done using air or fluid.

In certain embodiments, the coating paste is applied by any conventional means such as dipping the article in the paste, spreading the paste over the surface of the article or spraying the paste onto the surface of the article.

In certain embodiments, the method further includes the steps of heat treating the article to produce a desired coating thickness and microstructure, and finishing the article to obtain a desired surface appearance. It is envisioned that the external surfaces of the article can be treated or otherwise prepared before applying the paste to enhance coating adhesion.

In yet another aspect, the subject invention is also directed to a new and useful apparatus for injecting coating paste into an interior passage of an article having internal and external surfaces which form the internal passage within the article. In yet another aspect, the subject invention is also directed to a new and useful apparatus for injecting coating paste into the interior passages of the cooling passages of a turbine component. The apparatus includes a fixture for supporting an article or a turbine component having interior cooling passage, the fixture including an inlet portion for receiving coating paste and an outlet portion for delivering coating paste into the cooling passages of a turbine component. The apparatus further includes a hopper for storing coating paste, a pump assembly including a charging cylinder having a reciprocating piston for accumulating coating paste from the hopper, and for delivering accumulated coating paste to the inlet portion of the fixture, and a control valve in fluid communication with the fixture, the hopper and the pump assembly for controlling the flow of coating paste therebetween.

In an alternative embodiment, the invention is directed to the a method for delivering the coating paste by injection which uses a pressure vessel apparatus that stores and delivers the paste material in the manner described above while maintaining a consistent viscosity.

These and other aspects of the subject invention will become more readily apparent from the following detailed description of the embodiments taken in conjunction with the drawings.

### BRIEF DESCRIPTION OF THE DRAWINGS

So that those having ordinary skill in the art to which the subject invention pertains will more readily understand how to employ the coating process of the subject invention, particular embodiments thereof will be described in detail hereinbelow with reference to the drawings, wherein:

FIG. 1 is a photomicrograph illustrating a radial cooling passage surface of a turbine component coated in accordance with a particular embodiment of the subject invention, wherein the coating thickness is about 2 mils;

FIG. 2 is a photomicrograph illustrating a radial cooling passage surface of a turbine component coated in accordance with a particular embodiment of the subject invention, wherein the coating thickness is about 1 mil;

FIG. 3 is a photomicrograph illustrating a convoluted surface of an interior cooling passage of a turbine component coated in accordance with a particular embodiment of the subject invention;

FIG. 4 is a photomicrograph illustrating a localized view of the coated convoluted surface shown in FIG. 3;

FIG. 5 is a photomicrograph illustrating a radial cooling passage surface of a turbine component that has been slurry coated using commercially available materials;

FIG. 6 is a photomicrograph illustrating a localized view of the slurry coated surface structures shown in FIG. 5;

FIG. 7 is a photomicrograph illustrating slurry coated surface structures;

FIG. 8 is a photomicrograph illustrating a localized view of the slurry coated surface strictures shown in FIG. 7;

FIG. 9 is an illustration of an apparatus constructed in accordance with the subject invention for injecting an aluminide coating paste into the internal passages of a turbine component;

FIG. 10 is an illustration of an apparatus constructed in accordance with the subject invention for injecting an aluminide coating paste onto a component to be coated which uses a pressure vessel apparatus that stores and delivers the paste material in the manner described above while maintaining a consistent viscosity;

FIG. 11 is a process flow chart illustrating the steps taken in performing the paste coating process of the subject invention; and

FIG. 12 is a photograph of a sample sBlade Airfoil Section used in the comparative coating testing described in the Examples.

### DETAILED DESCRIPTION OF THE INVENTION

The subject invention is directed to a new and useful homogenous paste for forming a protective coating on a substrate surface.

In a particular embodiment, the homogenous paste of the invention is useful for depositing a protective coating on the internal surfaces of interior cooling passages of a turbine component, such as a vane, nozzle, bucket or blade which is made from a cobalt-based or nickel-based superalloy. It is envisioned that the homogenous paste disclosed herein can also be employed for coating selective exterior surface of an article such as a turbine component.

The subject invention is also directed to an apparatus for filling the interior cooling passages of a turbine component with the homogenous paste of the subject invention. In addition, the subject invention is directed to a process of applying a diffusion aluminide coating to an interior surface of a turbine component using the homogenous paste of the subject invention. Each of these aspects of the subject invention will be described in detail hereinbelow.

### 1. The Coating Paste

In one aspect, the invention provides a coating paste comprising a metallic aluminum alloy and a halide activator. In another aspect the invention provides a coating paste comprising a metallic aluminum alloy, a halide activator, and an organic binder or an inert filler. In still another aspect the invention provides a coating paste comprising a metallic aluminum alloy, a halide activator, and an organic binder and an inert filler.

In yet another aspect, the invention provides a coating paste comprising a metallic base component and an organic binder, wherein the metallic base component comprises a metallic aluminum alloy, a halide activator and an inert filler.

In aspects comprising a binder and/or a filler, the metallic aluminum alloy is carried by the organic binder and/or the inert filler for facilitating transfer of the aluminum in the metallic aluminum alloy to the substrate surface during a coating process.

The coating paste of the invention comprises an a metallic aluminum alloy. In certain embodiments the metallic aluminum alloy is a metallic aluminum alloy having a high melting temperature. In other embodiments, the metallic aluminum alloy is an aluminum alloy comprising a cobalt group metal. In other embodiments, the metallic aluminum alloy is an aluminum alloy comprising cobalt, rhodium, iridium or meitnerium or combinations thereof. In a specific embodiment, the metallic aluminum alloy is Co₂Al₉.

The coating paste of the invention comprises a halide activator. In certain embodiments, the halide activator used for aluminum transfer is a hygroscopic halide activator. In other embodiments, the halide activator used for aluminum transfer is a non-hygroscopic halide activator. In certain embodiments, halide activators include halide sources such as sources of fluorine, chlorine, iodine, and bromine. Halide activators include, but are not limited to, ammonium chloride, ammonium iodide, ammonium bromide, ammonium fluoride, ammonium bifluoride, elemental iodine, elemental bromine, hydrogen bromide, aluminum chloride, aluminum fluoride, aluminum bromide, and aluminum iodide. In particular embodiments, the halide activator is aluminum fluoride (AlF₃). In particular, aluminum fluoride is stable at desired coating temperatures, and given its hygroscopic properties, provides the paste with extended shelf life relative to other halide activators known in the art, such as ammonium bromide, ammonium chloride and or ammonium fluoride.

The coating paste of the invention comprises an organic binder. The selected binder should be chosen to be unreactive (inert) with the metallic aluminum alloy and the halide activator. The binder should be chosen to not dissolve the activator. A binder should be selected to promote an adequate shelf-life for the paste. A selected binder should also burn off cleanly and completely early in the coating process without interfering with the aluminization reactions. In certain embodiments, the organic binder is methyl cellulose and de-ionized water. In other embodiments, the organic binder is hydroxypropylcellulose. In still other embodiments, the organic binder is a petroleum-based or solvent-based binder. Suitable solvent-based binders include APVB4 binder and Hi TecMetal Group Type 215 binder. In yet other embodiments, suitable binders may be alcohol-based or water-based organic polymers, Commercial examples of suitable water-based organic polymeric binders include a polymeric gel available under the name Vitta Braz-Binder Gel from the Vitta Corporation. Suitable alcohol-based binders can be low molecular weight polyalcohols (polyols), such as polyvinyl alcohol (PVA). In certain embodiments, The binder may also incorporate a cure catalyst or accelerant such as sodium hypophosphite.

The coating paste also comprises an inert filler capable of preventing the metallic aluminum alloy from sintering when heated during the coating process. In certain embodiments, the inert filler includes, alumina or aluminum oxide (Al₂O₃), kaolin, MgO, SiO₂, Y₂O₃ or Cr₂O₃. The inert fillers may be used singly or in combination. In particular embodiments, the inert materials have a non-sintered, flowable grain structure. In specific embodiments, the filler is Al₂O₃. In certain embodiments of the invention, the coating paste of the invention does not comprise an inert filler.

In certain embodiments, the paste can also include a modifying element such as, for example, hafnium, yttrium, zirconium, chromium, and/or silicon, and combinations thereof.

In certain embodiments, the paste can also include a solvent. Suitable solvents include, but are not limited to, lower alcohols, N-methylpyrrolidone (NMP), and water to produce binder solutions having a wide range of viscosities. “Lower alcohols” are understood to be C₁-C₆ alcohols, such as ethyl alcohol and isopropyl alcohol. Other commercially available solvents are acceptable for the subject invention. The solvent's volatility, flammability, and toxicity are important commercial criteria to consider in selecting a solvent.

In accordance with another embodiment of the subject invention, different paste blends may be used to obtain a desired aluminide coating result on an internal surface of a cooling passage. In other words, the thickness and composition can be readily modified to suit a customer's requirements or a particular product design or coating specification. In particular embodiments, the coating paste of the invention has a viscosity between about 1,000 and about 250,000 centipoise.

In another aspect, the coating paste of the invention is prepared by first mixing the metallic aluminum alloy, the halide activator and the inert filler to form a metallic base component. The metallic base component is then mixed with the organic binder to form the coating paste of the invention. The metallic base component and the organic binder can be mixed by any conventional means known to those of skill in the art including, but not limited to, the use of inline mixers, batch mixers, high shear mixers, jet mixers, agitators, ball mills, colloid mills, cone mills, or kneaders.

In certain embodiments, the coating paste of the invention comprises metallic base component and organic binder in a ratio of from about 10:1 to about 1:10, from about 5:1 to about 1:5, from about 3:1 to about 1:3; from about 2:1 to about 1:2; or about 1:1 (metallic base component to organic binder).

In certain embodiments, the metallic base component comprises from about 1 wt % to about 50 wt % of metallic aluminum alloy. In other embodiments, the metallic base component comprises from about 3 wt % to about 40 wt % of metallic aluminum alloy. In still other embodiments, the metallic base component comprises from about 5 wt % to about 30 wt % of metallic aluminum alloy. In particular embodiments, the metallic base component comprises, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, or 30 wt % of metallic aluminum alloy.

Similarly, in certain embodiments, the metallic base component of the invention comprises from about 0.1 wt % to about 5.0 wt % of halide activator. In other embodiments, the metallic base component comprises from about 0.5 wt % to about 4.0 wt % of halide activator. In still other embodiments, the metallic base component comprises from about 1 wt % to about 3 wt % of halide activator. In particular embodiments, the metallic base component comprises, 0.5 wt %, 1 wt %, 1.5 wt %, 2.0 wt %, 2.5 wt %, 3.0 wt %, 3.5 wt %, 4.0 wt %, 4.5 wt %, or 5.0 wt % of halide activator.

In still other embodiments, the metallic base component of the invention comprises from about 45 wt % to about 99 wt % of inert filler. In other embodiments, the metallic base component comprises from about 55 wt % to about 97 wt % of inert filler. In still other embodiments, the metallic base component comprises from 65 wt % to about 94 wt % of inert filler. In particular embodiments, the metallic base component comprises, 45 wt %, 50 wt %, 55 wt %, 60 wt %, 65 wt %, 70 wt %, 75 wt %, 80 wt %, 85 wt %, 90 wt %, or 95.0 wt % of inert filler.

In particular embodiments, the paste comprises from 5-30 wt % of the metallic aluminum alloy and from 1-5 wt % of the halide depending upon the coating thickness and/or microstructure that is desired.

It will be apparent to one of skill in the art that the process can be tailored to deposit uniformly thick aluminides of different thicknesses and surface structures including inward surface structures, outward surface structures or hybrid inward/outward surface structures.

### 2. The Paste Injection Apparatus

2.1. Mechanical Piston Method

Referring to FIG. 9, there is illustrated an apparatus for filling the interior cooling passage of a turbine component with coating paste, which is constructed in accordance with a particular embodiment of the subject invention and which is designated generally by reference numeral 100. Apparatus 100 includes a mounting fixture 120 for supporting a turbine component 110 having interior cooling passage (not shown). The mounting fixture 120 includes an inlet side 122 for receiving coating paste from a horizontal feed conduit 124 and an outlet side 126 for delivering coating paste into the cooling passages of a turbine component 110. It is envisioned that the outlet side 126 would include one or more outlet ports communicating with a corresponding number of cooling passages formed in the component. Typically, a turbine blade or bucket includes a serpentine leading edge cooling circuit, a serpentine trailing edge cooling circuit and up to twelve discrete radial cooling passage that extend from the root of the component to the tip of the component. Thus, the outlet side of the fixture would have a corresponding number of outlet ports to accommodate the number, size and shape of the cooling passages.

The paste injection apparatus 100 further includes a hopper 130 for storing a sufficient volume of coating paste to fill a plurality of turbine components without replenishment. The hopper 130 preferably feeds paste into a vertical feed conduit 132 under gravity. However, it is envisioned that a weight or plunger may be provided within the hopper 130 to forcibly drive the paste into vertical feed conduit 132. Injection apparatus 100 further includes a pump assembly 140 that includes a charging cylinder 142 having a reciprocating piston 144 and an injection conduit 146. The charging cylinder is designed to accumulate coating paste from the hopper 130 when the piston 144 is drawn rearwardly and to deliver the paste to the fixture 120 when the piston 144 is driven forward. The pump assembly 140 further includes a pneumatic pump cylinder 148 for actuating the piston 144.

The paste filling apparatus 100 further includes a control valve 150 in fluid communication with the horizontal feed conduit 124 of fixture 120, the vertical feed conduit 132 of the hopper 130 and the injection conduit 146 of pump assembly 140 for controlling the flow of coating paste therebetween. In one position, the control valve 150 permits paste to be drawn from the hopper 130 into the charging cylinder 142, while preventing paste from traveling into the horizontal feed conduit 124 leading to the inlet side 122 of fixture 120. In another position, the control valve 150 permits paste to travel from the injection conduit 146 into the horizontal feed conduit 124, while blocking off the vertical feed conduit 132 leading from hopper 130. The control valve may be manually operated or automatically actuated. The pump cylinder 148 is adapted and configured to deliver paste at a rate of about 200 gms/min and at a supply pressure of about between 20 psi and 50 psi.

2.2 Pressure Vessel Method

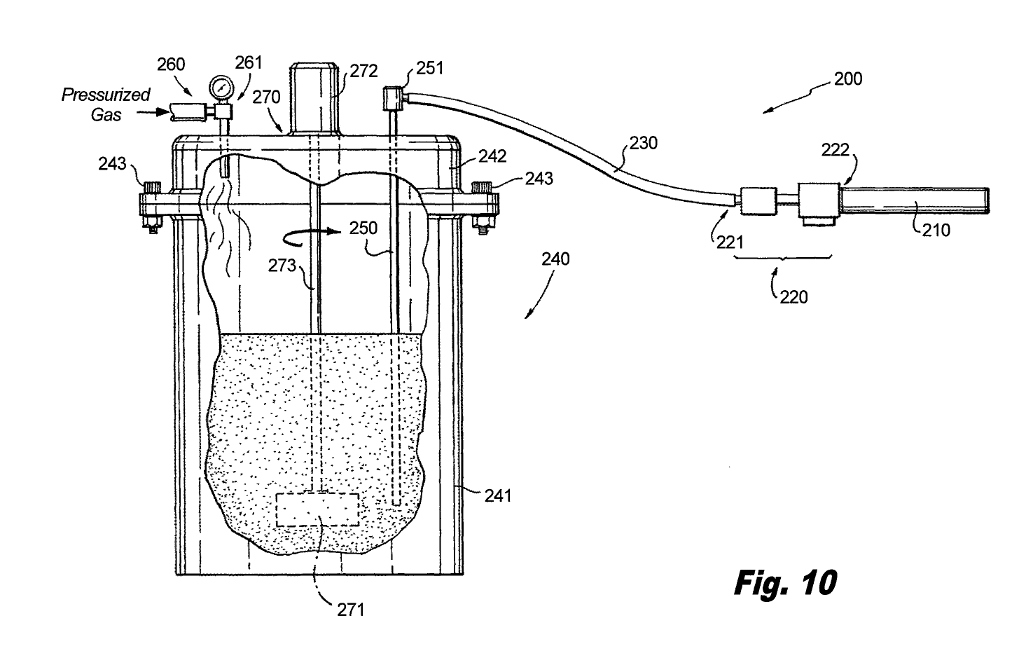

Referring to FIG. 10 there is illustrated an apparatus for filling the interior cooling passage of a turbine component with coating paste, which is constructed in accordance with a particular embodiment of the subject invention and which is designated generally by reference numeral 200. This system uses a pressure vessel that contains the paste material and is mixed to maintain a consistent viscosity. In certain embodiments, the paste material is mixed at regular intervals and for a set period of time. In certain other embodiments, the paste material is mixed continuously.

Apparatus 200 includes a mounting fixture 220 for supporting a turbine component 210 having interior cooling passage (not shown). The mounting fixture 220 includes an inlet side control valve 221 for receiving coating paste from a conduit, such as a rigid or flexible tube, 230 and an outlet side 222 for delivering coating paste into the cooling passages of a turbine component 210. It is envisioned that the outlet side 222 would include one or more outlet ports communicating with a corresponding number of cooling passages formed in the component. Typically, a turbine blade or bucket includes a serpentine leading edge cooling circuit, a serpentine trailing edge cooling circuit and up to twelve discrete radial cooling passage that extend from the root of the component to the tip of the component. Thus, the outlet side of the fixture would have a corresponding number of outlet ports to accommodate the number, size and shape of the cooling passages.

The paste injection apparatus 200 further includes a hopper 240 for storing a sufficient volume of coating paste to fill a plurality of turbine components without replenishment. The hopper 240 preferably feeds paste into the conduit 230 through a vertical feed tube 250 and a conduit connector 251. In certain embodiments, the hopper 240 is composed of a container 241 and a cover 242 which is secured by a plurality of clamps or bolts 243 which are capable of sealing the container and maintaining an increased pressure.

The paste is pressure fed into the feed tube, typically by the addition of pressurized gas, such as compressed air, nitrogen, argon, or hydrogen, through a pressure inlet 260 equipped in the cover 242 of the hopper 240. The pressure inlet is equipped with a pressure regulator and gauge device 261.

The hopper 240 is also equipped with a mixing apparatus 270 comprising a mixing device 271 attached to a mixing motor 272 by a mixing shaft 273. The mixing shaft 273 passes through the cover 242 and is secured such that the seal is maintained by the cover while mixing.

### 3. The Paste Coating Process

The coating paste of the invention can be used to coat any desired article. In general, the coating paste is used to coat the internal surfaces of an article having an internal surface and an external surface, including, but not limited to, pipes, flexible or rigid tubes, flexible or rigid hoses, jet nozzles, propelling nozzles, spray nozzles, shaping nozzles, high velocity nozzles, vanes, blades, or buckets. In a particular embodiment, the article to be coated is a turbine component. In some embodiments, the coating paste can be used to coat the external surfaces of an article. In such embodiments, the paste can be applied by any means known to those of skill in the art including, but not limited to, spraying, dipping or spreading the coating onto the surface. Similarly, in such embodiments, the article would then be heated in a furnace within a predetermined temperature range of about between 1500° F. and 2100° F. for a sufficient time period to obtain a desired aluminide coating on article to be coated.

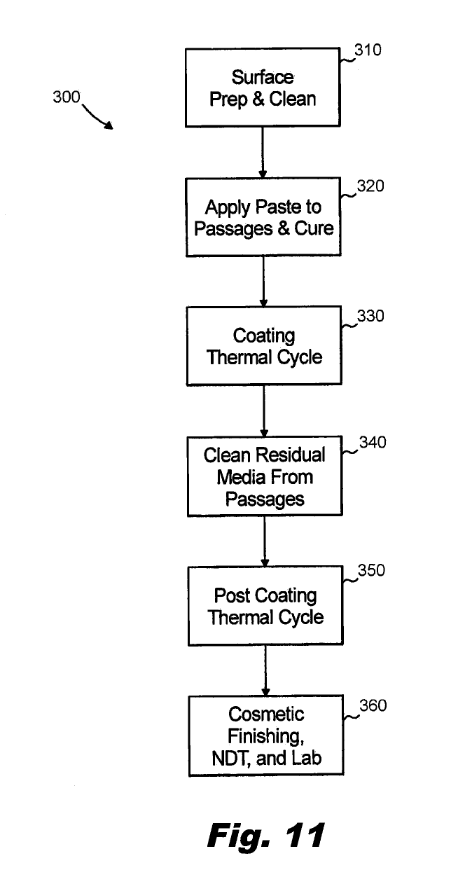

Referring now to FIG. 11, there is illustrated a flow chart 300 identifying the operative steps involved in the process of applying a protective coating to the internal surfaces of the cooling passages of a turbine component in accordance with a particular embodiment of the subject invention. Initially, if desired, the internal surfaces of the cooling passages can be treated or otherwise prepared before injecting the paste into the passages at step 310, to enhance coating adhesion. This can be done using a liquid cleaning fluid or by way of ultrasonic cleaning to remove grease and oil from the surfaces.

At step 320, an aluminide paste is injected into the cooling passages of the turbine component and cured. This can be accomplished utilizing the injection apparatus 100 described above and illustrated in FIG. 9 or the injection apparatus 200 described above and illustrated in FIG. 10. Alternative injection devices and filling methods can also be employed. The aluminide paste is cured at a temperature in the range of about 150° F. to 200° F. to stabilize the material. This causes the water in the paste to evaporate before its boils, which can create unwanted voids in the paste.

Then, at step 320 the turbine component is heated in a furnace within a predetermined temperature range of about between 1500° F. and 2100° F. for a sufficient time period to obtain a desired aluminide coating on the internal surfaces of the cooling passages. As the component is heated in the furnace, the binder system is vaporized, turning to ash, at temperatures well below a relevant coating temperature. The latent halide activator AlF₃ then reacts at a higher temperature with the aluminum alloy Co₂Al₉ to deposit aluminum on the interior substrate surfaces and thereby form the diffusion aluminide coating.

During the thermal cycle of step 330, the time period for heating the turbine component within the furnace can vary from 2 to 8 hours, although it is preferable to heat the component for a period of about between 4 to 6 hours. The extent of the time period depends largely upon amount of aluminum alloy that is available in the paste for diffusion onto the substrate surfaces. Process step 330 is performed in a controlled atmosphere such as argon or hydrogen, and in full vacuum or under partial pressure.

The method further includes the step 340 of removing any residual paste or ash from the cooling passages after it is removed from the furnace. This may be done using forced air or a fluid wash, and then the component may be rinsed or dried as necessary. Because the paste coating process of the subject invention utilizes a relatively viscous coating media that can be injected into the interior cooling passage of a turbine component in a controlled manner, there is little if any aluminide bleed on to the exterior surfaces of the component not requiring coating. This characteristic is useful when applied to a turbine component that requires internal aluminide coating and an external metallic or combination metallic/ceramic thermal barrier (TBC) coating. The external coating systems typically applied by a thermal spray process must be free of aluminide coating to assure the adhesion properties of the coating. If aluminide coating is present, (a typical result with vapor phase or pack cementation) it must be removed by mechanical or chemical stripping prior to the thermal spray coating application. Due to the precise application of the subject invention the coating removal step would not be required and thus lower the overall cost of the component coating processes.

The method further includes the steps of heat treating the turbine component at step 350 to produce a desired coating thickness and microstructure, and finishing the turbine component at step 360 to obtain a desired surface appearance. The resulting protective coating is adherent to base alloy and has a uniform continuous surface free from chipping, cracking, spalling or adherent particles. The coating surface finish is typically of that which is obtained by pack cementation and vapor phase processes. In the course of the coating run, coating analysis is preferably performed using representative samples.

In sum, the paste compositions and process of the subject invention produces coating thicknesses, microstructures, and aluminide content similar to the current available pack cementation or vapor coating processes without the variation in coating distribution or the high costs associated with VPA/CVD tooling. Unlike the disadvantages of a pack cementation powder process, the paste media of the subject invention does not lose its chemical consistency when it is injected into internal passages of a turbine component. This characteristic produces a uniform coating distribution on all surfaces. In addition, the paste is able to produce acceptable coatings in components with various levels for surface oxides or scale. This is an advantage when coating engine run overhaul components or parts with debris from previous processing operations that may inhibit the diffusion process.

### EXAMPLES

The structures, materials, compositions, and methods described herein are intended to be representative examples of the invention, and it will be understood that the scope of the invention is not limited by the scope of the examples. Those skilled in the art will recognize that the invention may be practiced with variations on the disclosed structures, materials, compositions and methods, and such variations are regarded as within the ambit of the invention.

The following examples illustrate various exemplary embodiments of the methods described in this disclosure.

### Preparation of the Metallic Base Component

In general, the metallic base component is prepared through powder blending. Each component material (metallic aluminum alloy, halide activator and inert filler) is weighed based on the percentage of ingredient used and total weight of the metallic base component powder blend.

In the coating pastes described below, the ingredients for the metallic base component powder blend were cobalt aluminum (Co₂Al₉), aluminum fluoride (AlF₃) and aluminum oxide (Al₂O₃). All (3) ingredients were loaded into a powder blender and mixed for 30-60 minutes. After blending, the mixture was given a batch identifier and was ready for use in preparing the coating paste

### Preparation of Organic Binder

Methyl Cellulose Blending

4000 ml of deionized water was added into a Hobart mixing bowl. 50 grams of methyl cellulose powder was measured. The mixer was set to run at setting #1. A small amount of methyl cellulose powder was sprinkled into the mixing bowl. Small amounts of methyl cellulose powder were added into the mixing bowl until all 50 grams were added. The binder component was to mix for 1-1.5 hours or until the mixture appeared lump free. When complete, the mixture was poured into a clean bucket and capped for storage. The mixture was then given a batch identifier and allowed to sit for a minimum of 8 hours prior to use to remove all air bubbles.

### Preparation of the Coating Paste

Paste Blending

2000 grams of the metallic base component powder blend was added to a Hobart mixing bowl. Next, 1500 grams of the binder component was added to the Hobart mixing bowl. The mixer was set to setting #1 and allowed blend for 15 minutes. After the mixing was complete, the paste was ready for use or storage. Fifteen representative blends of paste were prepared and are described in Table A below as Blend A-Blend O.

TABLE A

| | | | | | Organic |
|---|---|---|---|---|---|
| | | | | | Binder |
| | | | | | (Methyl |
| | Metallic Base Component (MBC) | | | Metallic | Cellulose |
| | % (of MBC) | | | Base | and |
| | | | Inert Filler | Com- | Deionized |
| | Cobalt | Aluminum | Aluminum | ponent | Water) |
| | Aluminum | Fluoride | Oxide | % (of | % (of |
| Blend | (Co₂Al₉) % | (AlF₃) % | (Al₂O₃) % | total) | total) |
| Blend A | 5 | 1 | 94 | 50%-60% | 40%-50% |
| Blend B | 5 | 2 | 93 | 50%-60% | 40%-50% |
| Blend C | 5 | 3 | 92 | 50%-60% | 40%-50% |
| Blend D | 10 | 1 | 89 | 50%-60% | 40%-50% |
| Blend E | 10 | 2 | 88 | 50%-60% | 40%-50% |
| Blend F | 10 | 3 | 87 | 50%-60% | 40%-50% |
| Blend G | 15 | 1 | 84 | 50%-60% | 40%-50% |
| Blend H | 15 | 2 | 83 | 50%-60% | 40%-50% |
| Blend I | 15 | 3 | 82 | 50%-60% | 40%-50% |
| Blend J | 20 | 1 | 79 | 50%-60% | 40%-50% |
| Blend K | 20 | 2 | 78 | 50%-60% | 40%-50% |
| Blend L | 20 | 3 | 77 | 50%-60% | 40%-50% |
| Blend M | 30 | 1 | 69 | 50%-60% | 40%-50% |
| Blend N | 30 | 2 | 68 | 50%-60% | 40%-50% |
| Blend O | 30 | 3 | 67 | 50%-60% | 40%-50% |

### Coating of a Turbine Blade

The turbine blade was loaded into a coating furnace. The coating furnace, parts/boxes or furnace racks were heated to the range of 1500° F.+/−25° F. to 1975° F.+/−25° F. in a cover gas of argon or hydrogen or in vacuum or vacuum partial pressure for a sufficient time to meet desired coating requirements.

The parts to be coated were air blown-out, water washed, scrubbed, rinsed and dried as required.

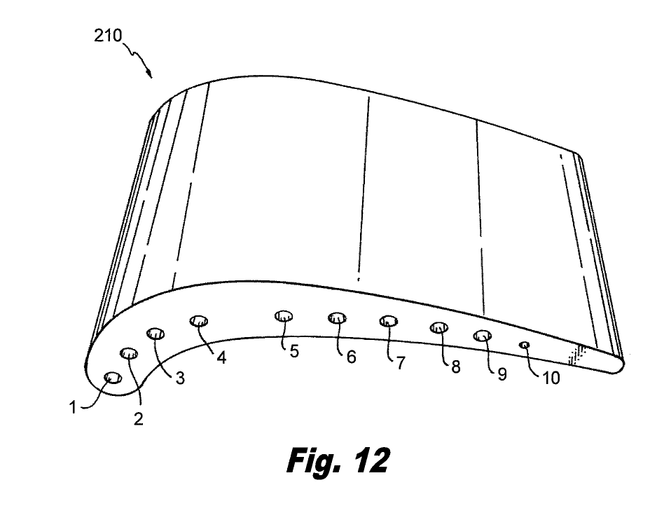

Tables 1-12 show coating results for ten radial cooling passages formed in a Blade Airfoil Section (see FIG. 12) using from 5-20 wt % Co₂Al₉ and from 1-3 wt % AlF₃, and using identical coating process conditions and identical post-coating thermal cycle treatment. The tabulated results establish that the use of the subject aluminide paste having a controlled alloy/activator chemistry enables the user to have a high degree of control over the coating process, so as to obtain a desired aluminide coating thickness. In each of the tables, the coating thickness was measured in each of the 10 holes shown in FIG. 12. The average diameter of the holes was approximately 0.116 inches.

The test was conducted four times (Columns labeled 1, 2, 3, and 4) and the Average coating thickness, Maximum thickness, Minimum thickness and Standard Deviations were calculated and recorded

TABLE 1
Coating Mix Blend A

| | | | | | Average Coating | | | |
|---|---|---|---|---|---|---|---|---|
| Hole # | 1 | 2 | 3 | 4 | Thickness | Max | Min | Std-Dev |
| 1 | 1.0 | 1.1 | 1.2 | 1.0 | 1.1 | 1.2 | 1.0 | 0.10 |
| 2 | 1.0 | 0.9 | 0.7 | 1.1 | 0.9 | 1.1 | 0.7 | 0.17 |
| 3 | 1.3 | 1.3 | 1.2 | 1.3 | 1.3 | 1.3 | 1.2 | 0.05 |
| 4 | 1.2 | 1.4 | 1.2 | 1.3 | 1.3 | 1.4 | 1.2 | 0.10 |
| 5 | 1.2 | 1.2 | 1.2 | 1.3 | 1.2 | 1.3 | 1.2 | 0.05 |
| 6 | 1.3 | 1.1 | 1.2 | 1.3 | 1.2 | 1.3 | 1.1 | 0.10 |
| 7 | 1.2 | 1.1 | 1.1 | 1.3 | 1.2 | 1.3 | 1.1 | 0.10 |
| 8 | 1.2 | 1.1 | 1.2 | 1.2 | 1.2 | 1.2 | 1.1 | 0.05 |
| 9 | 1.1 | 1.2 | 1.1 | 1.2 | 1.2 | 1.2 | 1.1 | 0.06 |
| 10 | 0.7 | 0.8 | 1.0 | 0.7 | 0.8 | 1.0 | 0.7 | 0.14 |

TABLE 2
Coating Mix Blend B

| | | | | | Average Coating | | | |
|---|---|---|---|---|---|---|---|---|
| Hole # | 1 | 2 | 3 | 4 | Thickness | Max | Min | Std-Dev |
| 1 | 1.4 | 1.3 | 1.5 | 1.4 | 1.4 | 1.5 | 1.3 | 0.08 |
| 2 | 1.3 | 1.3 | 1.5 | 1.3 | 1.4 | 1.5 | 1.3 | 0.10 |
| 3 | 1.2 | 1.1 | 1.3 | 1.4 | 1.3 | 1.4 | 1.1 | 0.13 |
| 4 | 1.0 | 1.4 | 1.6 | 1.3 | 1.3 | 1.6 | 1.0 | 0.25 |
| 5 | 1.2 | 1.3 | 1.4 | 1.5 | 1.4 | 1.5 | 1.2 | 0.13 |
| 6 | 1.2 | 1.3 | 1.5 | 1.2 | 1.3 | 1.5 | 1.2 | 0.14 |
| 7 | 1.2 | 1.3 | 1.3 | 1.3 | 1.3 | 1.3 | 1.2 | 0.05 |
| 8 | 1.2 | 1.1 | 1.5 | 1.3 | 1.3 | 1.5 | 1.1 | 0.17 |
| 9 | 1.2 | 1.2 | 1.3 | 1.3 | 1.3 | 1.3 | 1.2 | 0.06 |
| 10 | 0.7 | 0.8 | 0.8 | 0.6 | 0.7 | 0.8 | 0.6 | 0.10 |

TABLE 3
Coating Mix Blend C

| | | | | | Average Coating | | | |
|---|---|---|---|---|---|---|---|---|
| Hole # | 1 | 2 | 3 | 4 | Thickness | Max | Min | Std-Dev |
| 1 | 1.4 | 1.1 | 1.2 | 1.3 | 1.3 | 1.4 | 1.1 | 0.13 |
| 2 | 1.2 | 1.4 | 1.5 | 1.1 | 1.3 | 1.5 | 1.1 | 0.18 |
| 3 | 1.3 | 1.1 | 1.3 | 1.3 | 1.3 | 1.3 | 1.1 | 0.10 |
| 4 | 1.3 | 1.2 | 1.2 | 1.4 | 1.3 | 1.4 | 1.2 | 0.10 |
| 5 | 1.3 | 1.2 | 1.3 | 1.3 | 1.3 | 1.3 | 1.2 | 0.05 |
| 6 | 1.3 | 1.1 | 1.2 | 1.0 | 1.2 | 1.3 | 1.0 | 0.13 |
| 7 | 1.1 | 1.3 | 1.0 | 1.0 | 1.1 | 1.3 | 1.0 | 0.14 |
| 8 | 0.8 | 0.9 | 0.7 | 1.0 | 0.9 | 1.0 | 0.7 | 0.13 |
| 9 | 0.9 | 0.9 | 1.0 | 1.1 | 1.0 | 1.1 | 0.9 | 0.10 |
| 10 | 0.6 | 0.5 | 0.5 | 0.7 | 0.6 | 0.7 | 0.5 | 0.10 |

TABLE 4
Coating Mix Blend D

| | | | | | Average Coating | | | |
|---|---|---|---|---|---|---|---|---|
| Hole # | 1 | 2 | 3 | 4 | Thickness | Max | Min | Std-Dev |
| 1 | 1.4 | 1.6 | 1.7 | 1.5 | 1.6 | 1.7 | 1.4 | 0.13 |
| 2 | 1.5 | 1.5 | 1.3 | 1.5 | 1.5 | 1.5 | 1.3 | 0.10 |
| 3 | 1.5 | 1.6 | 1.5 | 1.6 | 1.6 | 1.6 | 1.5 | 0.06 |
| 4 | 1.7 | 1.6 | 1.6 | 1.5 | 1.6 | 1.7 | 1.5 | 0.08 |
| 5 | 1.5 | 1.3 | 1.7 | 1.5 | 1.5 | 1.7 | 1.3 | 0.16 |
| 6 | 1.3 | 1.5 | 1.5 | 1.5 | 1.5 | 1.5 | 1.3 | 0.10 |
| 7 | 1.4 | 1.5 | 1.5 | 1.4 | 1.5 | 1.5 | 1.4 | 0.06 |
| 8 | 1.3 | 1.3 | 1.4 | 1.4 | 1.4 | 1.4 | 1.3 | 0.06 |
| 9 | 1.3 | 1.2 | 1.6 | 1.5 | 1.4 | 1.6 | 1.2 | 0.18 |
| 10 | 1.0 | 1.2 | 1.0 | 1.0 | 1.1 | 1.2 | 1.0 | 0.10 |

TABLE 5
Coating Mix Blend E

| | | | | | Average Coating | | | |
|---|---|---|---|---|---|---|---|---|
| Hole # | 1 | 2 | 3 | 4 | Thickness | Max | Min | Std-Dev |
| 1 | 1.5 | 1.8 | 1.8 | 1.9 | 1.8 | 1.9 | 1.5 | 0.17 |
| 2 | 1.5 | 1.6 | 1.5 | 2.0 | 1.7 | 2.0 | 1.5 | 0.24 |
| 3 | 1.8 | 1.6 | 1.6 | 1.9 | 1.7 | 1.9 | 1.6 | 0.15 |
| 4 | 1.6 | 1.8 | 1.4 | 2.0 | 1.7 | 2.0 | 1.4 | 0.26 |
| 5 | 1.5 | 1.7 | 1.8 | 1.7 | 1.7 | 1.8 | 1.5 | 0.13 |
| 6 | 1.8 | 1.6 | 1.7 | 1.7 | 1.7 | 1.8 | 1.6 | 0.08 |
| 7 | 1.7 | 1.8 | 1.6 | 1.7 | 1.7 | 1.8 | 1.6 | 0.08 |
| 8 | 1.6 | 1.7 | 1.7 | 1.7 | 1.7 | 1.7 | 1.6 | 0.05 |
| 9 | 1.7 | 1.8 | 1.8 | 1.6 | 1.7 | 1.8 | 1.6 | 0.10 |
| 10 | 1.3 | 1.3 | 1.5 | 1.4 | 1.4 | 1.5 | 1.3 | 0.10 |

TABLE 6
Coating Mix Blend F

| | | | | | Average Coating | | | |
|---|---|---|---|---|---|---|---|---|
| Hole # | 1 | 2 | 3 | 4 | Thickness | Max | Min | Std-Dev |
| 1 | 1.7 | 1.8 | 1.8 | 2.0 | 1.8 | 2.0 | 1.7 | 0.13 |
| 2 | 1.5 | 1.6 | 1.8 | 1.8 | 1.7 | 1.8 | 1.5 | 0.15 |
| 3 | 1.5 | 1.7 | 1.6 | 2.0 | 1.7 | 2.0 | 1.5 | 0.22 |
| 4 | 1.6 | 1.8 | 1.5 | 1.9 | 1.7 | 1.9 | 1.5 | 0.18 |
| 5 | 1.5 | 1.6 | 1.7 | 1.8 | 1.7 | 1.8 | 1.5 | 0.13 |
| 6 | 1.4 | 1.7 | 1.8 | 1.5 | 1.6 | 1.8 | 1.4 | 0.18 |
| 7 | 1.5 | 1.7 | 2.0 | 1.7 | 1.7 | 2.0 | 1.5 | 0.21 |
| 8 | 1.5 | 1.8 | 1.5 | 1.7 | 1.6 | 1.8 | 1.5 | 0.15 |
| 9 | 1.5 | 1.6 | 1.7 | 1.6 | 1.6 | 1.7 | 1.5 | 0.08 |
| 10 | 1.4 | 1.6 | 1.5 | 1.3 | 1.5 | 1.6 | 1.3 | 0.13 |

TABLE 7
Coating Mix Blend G

| | | | | | Average Coating | | | |
|---|---|---|---|---|---|---|---|---|
| Hole # | 1 | 2 | 3 | 4 | Thickness | Max | Min | Std-Dev |
| 1 | 1.9 | 2.1 | 2.0 | 2.0 | 2.0 | 2.1 | 1.9 | 0.08 |
| 2 | 2.3 | 2.1 | 2.1 | 2.2 | 2.2 | 2.3 | 2.1 | 0.10 |
| 3 | 2.3 | 2.2 | 2.0 | 1.9 | 2.1 | 2.3 | 1.9 | 0.18 |
| 4 | 2.1 | 2.1 | 2.1 | 2.0 | 2.1 | 2.1 | 2.0 | 0.05 |
| 5 | 1.9 | 1.9 | 1.7 | 1.9 | 1.9 | 1.9 | 1.7 | 0.10 |
| 6 | 1.7 | 1.8 | 1.7 | 1.7 | 1.7 | 1.8 | 1.7 | 0.05 |
| 7 | 0.8 | 1.0 | 1.1 | 0.7 | 0.9 | 1.1 | 0.7 | 0.18 |
| 8 | 1.6 | 1.7 | 1.7 | 1.8 | 1.7 | 1.8 | 1.6 | 0.08 |
| 9 | 1.5 | 1.7 | 1.6 | 1.6 | 1.6 | 1.7 | 1.5 | 0.08 |
| 10 | 1.4 | 1.5 | 1.4 | 1.4 | 1.4 | 1.5 | 1.4 | 0.05 |

TABLE 8
Coating Mix Blend H

| | | | | | Average Coating | | | |
|---|---|---|---|---|---|---|---|---|
| Hole # | 1 | 2 | 3 | 4 | Thickness | Max | Min | Std-Dev |
| 1 | 1.7 | 2.1 | 1.8 | 2.3 | 2.0 | 2.3 | 1.7 | 0.28 |
| 2 | 2.1 | 2.0 | 2.3 | 1.8 | 2.1 | 2.3 | 1.8 | 0.21 |
| 3 | 2.3 | 2.5 | 2.0 | 1.9 | 2.2 | 2.5 | 1.9 | 0.28 |
| 4 | 1.8 | 2.2 | 1.9 | 2.1 | 2.0 | 2.2 | 1.8 | 0.18 |
| 5 | 2.3 | 2.0 | 1.8 | 2.1 | 2.1 | 2.3 | 1.8 | 0.21 |
| 6 | 2.3 | 2.1 | 2.0 | 2.2 | 2.2 | 2.3 | 2.0 | 0.13 |
| 7 | 2.1 | 2.0 | 2.2 | 2.1 | 2.1 | 2.2 | 2.0 | 0.08 |
| 8 | 1.8 | 1.6 | 2.2 | 1.9 | 1.9 | 2.2 | 1.6 | 0.25 |
| 9 | 2.0 | 2.2 | 2.3 | 1.8 | 2.1 | 2.3 | 1.8 | 0.22 |
| 10 | 2.1 | 1.7 | 1.9 | 1.8 | 1.9 | 2.1 | 1.7 | 0.17 |

TABLE 9
Coating Mix Blend I

| | | | | | Average Coating | | | |
|---|---|---|---|---|---|---|---|---|
| Hole # | 1 | 2 | 3 | 4 | Thickness | Max | Min | Std-Dev |
| 1 | 2.5 | 2.6 | 2.4 | 2.3 | 2.5 | 2.6 | 2.3 | 0.13 |
| 2 | 2.5 | 2.5 | 2.7 | 2.4 | 2.5 | 2.7 | 2.4 | 0.13 |
| 3 | 3.0 | 2.3 | 2.5 | 2.8 | 2.7 | 3.0 | 2.3 | 0.31 |
| 4 | 2.5 | 2.4 | 2.5 | 2.3 | 2.4 | 2.5 | 2.3 | 0.10 |
| 5 | 2.3 | 2.5 | 2.2 | 2.3 | 2.3 | 2.5 | 2.2 | 0.13 |
| 6 | 2.3 | 2.1 | 2.4 | 2.6 | 2.4 | 2.6 | 2.1 | 0.21 |
| 7 | 2.3 | 2.1 | 2.3 | 2.2 | 2.2 | 2.3 | 2.1 | 0.10 |
| 8 | 1.8 | 2.0 | 1.8 | 1.8 | 1.9 | 2.0 | 1.8 | 0.10 |
| 9 | 1.8 | 1.9 | 2.3 | 1.9 | 2.0 | 2.3 | 1.8 | 0.22 |
| 10 | 1.5 | 1.9 | 1.4 | 1.5 | 1.6 | 1.9 | 1.4 | 0.22 |

TABLE 10
Coating Mix Blend J

| | | | | | Average Coating | | | |
|---|---|---|---|---|---|---|---|---|
| Hole # | 1 | 2 | 3 | 4 | Thickness | Max | Min | Std-Dev |
| 1 | 1.4 | 1.3 | 1.5 | 1.3 | 1.4 | 1.5 | 1.3 | 0.10 |
| 2 | 1.2 | 1.1 | 1.3 | 1.3 | 1.2 | 1.3 | 1.1 | 0.10 |
| 3 | 1.3 | 1.4 | 1.2 | 1.2 | 1.3 | 1.4 | 1.2 | 0.10 |
| 4 | 2.0 | 1.7 | 1.6 | 2.0 | 1.8 | 2.0 | 1.6 | 0.21 |
| 5 | 1.4 | 1.3 | 1.3 | 1.3 | 1.3 | 1.4 | 1.3 | 0.05 |
| 6 | 1.3 | 1.2 | 1.3 | 1.5 | 1.3 | 1.5 | 1.2 | 0.13 |
| 7 | 1.7 | 2.0 | 1.8 | 1.8 | 1.8 | 2.0 | 1.7 | 0.13 |
| 8 | 1.3 | 1.3 | 1.4 | 1.5 | 1.4 | 1.5 | 1.3 | 0.10 |
| 9 | 1.1 | 1.4 | 1.3 | 1.4 | 1.3 | 1.4 | 1.1 | 0.14 |
| 10 | 0.6 | 0.8 | 0.9 | 0.7 | 0.8 | 0.9 | 0.6 | 0.13 |

TABLE 11
Coating Mix Blend K

| | | | | | Average Coating | | | |
|---|---|---|---|---|---|---|---|---|
| Hole # | 1 | 2 | 3 | 4 | Thickness | Max | Min | Std-Dev |
| 1 | 2.5 | 2.5 | 2.8 | 2.4 | 2.6 | 2.8 | 2.4 | 0.17 |
| 2 | 2.8 | 2.7 | 2.4 | 2.6 | 2.6 | 2.8 | 2.4 | 0.17 |
| 3 | 2.7 | 2.4 | 2.5 | 2.7 | 2.6 | 2.7 | 2.4 | 0.15 |
| 4 | 2.7 | 2.8 | 2.5 | 2.5 | 2.6 | 2.8 | 2.5 | 0.15 |
| 5 | 2.5 | 2.8 | 2.5 | 2.6 | 2.6 | 2.8 | 2.5 | 0.14 |
| 6 | 2.5 | 2.7 | 2.6 | 2.6 | 2.6 | 2.7 | 2.5 | 0.08 |
| 7 | 2.3 | 2.5 | 2.6 | 2.4 | 2.5 | 2.6 | 2.3 | 0.13 |
| 8 | 2.3 | 2.4 | 2.5 | 2.3 | 2.4 | 2.5 | 2.3 | 0.10 |
| 9 | 2.3 | 2.3 | 2.8 | 2.6 | 2.5 | 2.8 | 2.3 | 0.24 |
| 10 | 2.3 | 2.4 | 2.2 | 2.3 | 2.3 | 2.4 | 2.2 | 0.08 |

TABLE 12
Coating Mix Blend L

| | | | | | Average Coating | | | |
|---|---|---|---|---|---|---|---|---|
| Hole # | 1 | 2 | 3 | 4 | Thickness | Max | Min | Std-Dev |
| 1 | 3.5 | 3.5 | 3.2 | 3.5 | 3.4 | 3.5 | 3.2 | 0.15 |
| 2 | 3.2 | 3.3 | 3.2 | 3.1 | 3.2 | 3.3 | 3.1 | 0.08 |
| 3 | 3.3 | 3.4 | 3.5 | 3.2 | 3.4 | 3.5 | 3.2 | 0.13 |
| 4 | 3.4 | 3.5 | 3.5 | 3.3 | 3.4 | 3.5 | 3.3 | 0.10 |
| 5 | 3.5 | 3.3 | 3.5 | 3.4 | 3.4 | 3.5 | 3.3 | 0.10 |
| 6 | 2.9 | 2.8 | 2.9 | 2.8 | 2.9 | 2.9 | 2.8 | 0.06 |
| 7 | 2.8 | 2.9 | 3.0 | 3.0 | 2.9 | 3.0 | 2.8 | 0.10 |
| 8 | 2.6 | 2.6 | 2.5 | 2.6 | 2.6 | 2.6 | 2.5 | 0.05 |
| 9 | 2.6 | 3.1 | 2.9 | 2.8 | 2.9 | 3.1 | 2.6 | 0.21 |
| 10 | 2.1 | 2.7 | 1.8 | 2.2 | 2.2 | 2.7 | 1.8 | 0.37 |

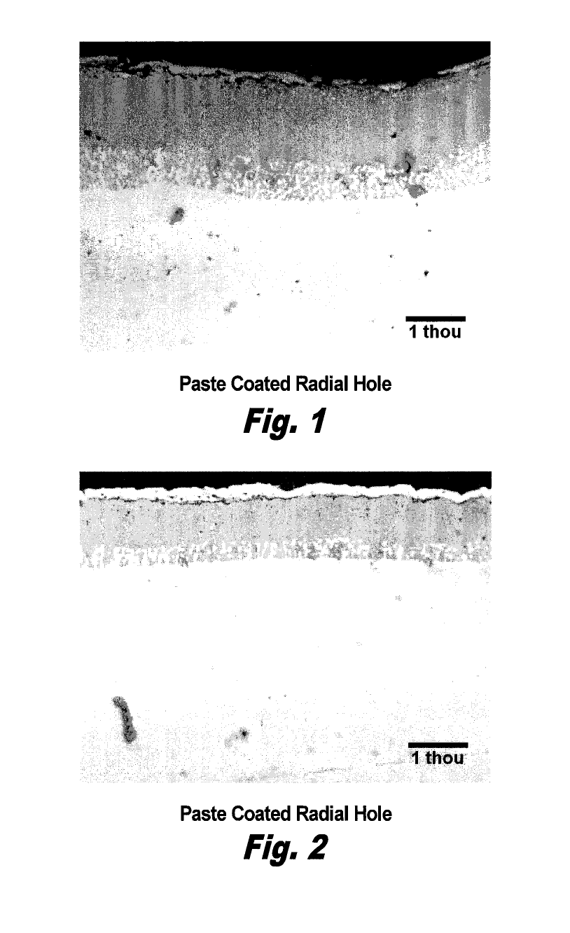

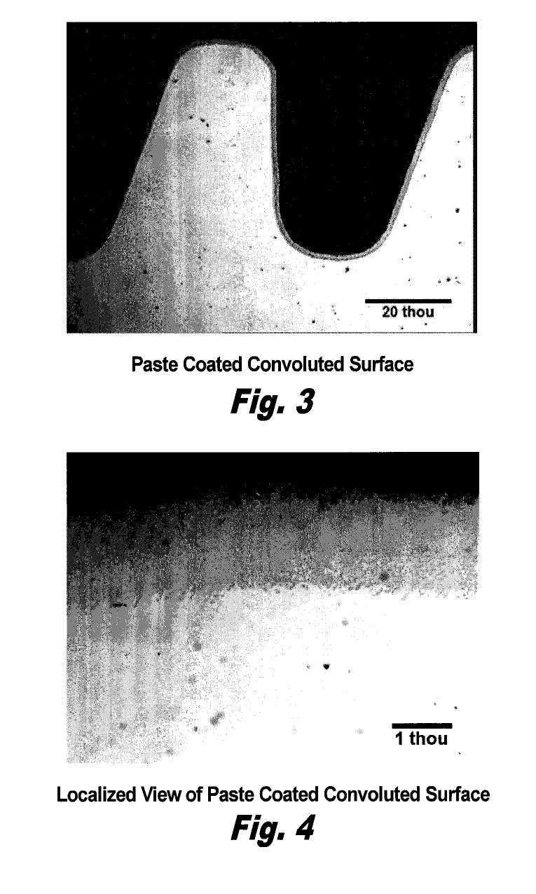

Referring now to FIGS. 1-4, there is illustrated a series of photomicrographs depicting aluminide coatings applied to different interior surfaces of a turbine component using the coating paste and process of the subject invention. In particular, FIGS. 1 and 2 depict aluminide coatings having respective thicknesses of 2 mils and 1 mil, applied to the interior surfaces of radial cooling passages. FIG. 3 is a photomicrograph depicting an aluminide coating applied to the surface of a convoluted cooling passage, and FIG. 4 is an enlarged localized view of the peak of the convolution shown in FIG. 3. It is readily apparent from FIGS. 1-4, that the paste coating process of the subject invention produces a smooth continuous aluminide coating on the substrate surface.

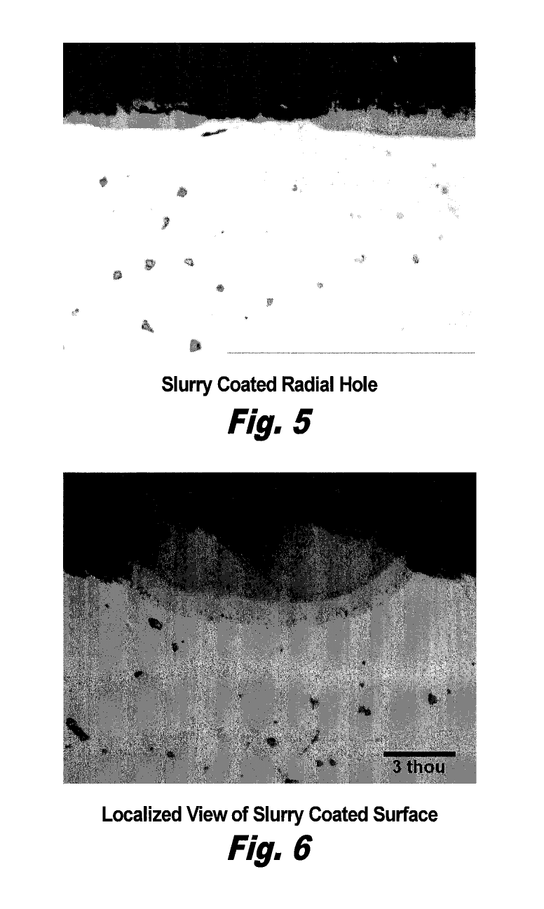

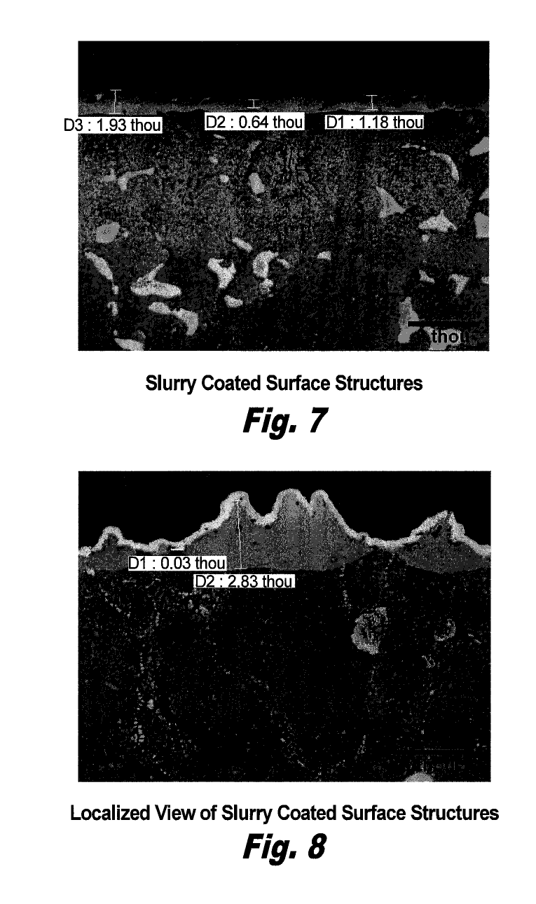

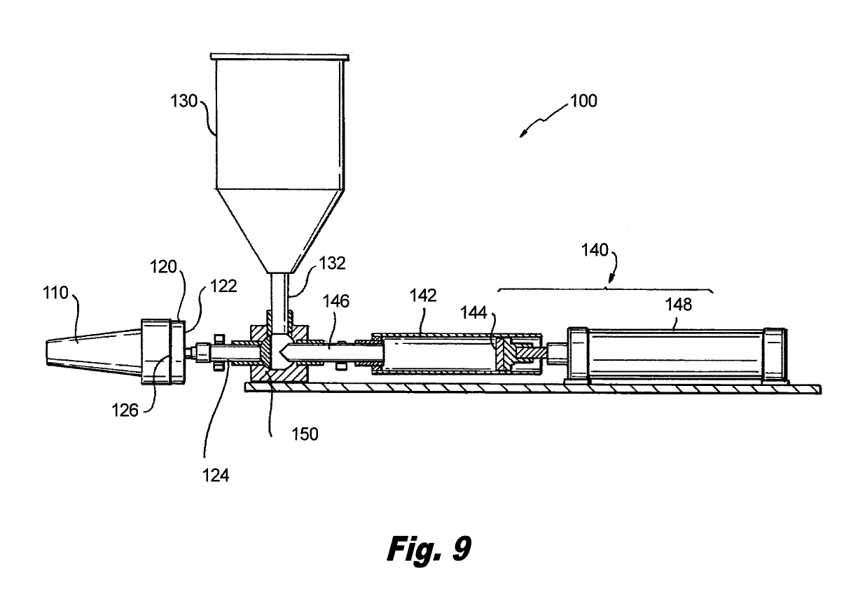

By way of comparison, FIGS. 5-8 are photomicrographs depicting interior component surfaces that have been coated using a conventional slurry coating process, under the same process conditions used to obtain the coating shown in FIGS. 1-4. It is readily apparent that coatings applied using a slurry are distributed in a discontinuous manner and possess a random saw toothed surface structure. This result is largely due to a low melting aluminum alloy source becoming unevenly distributed within the slurry during the coating process.

### INCORPORATION BY REFERENCE

The entire contents of all patents published patent applications and other references cited herein are hereby expressly incorporated herein in their entireties by reference.

### EQUIVALENTS

Those skilled in the art will recognize, or be able to ascertain using no more than routine experimentation, numerous equivalents to the specific procedures described herein. Such equivalents are considered to be within the scope of this invention and are covered by the following Claims.

What is claimed is:

1. A homogenous paste for forming a protective coating on a substrate surface, comprising:
a) a metallic base component; and
b) an organic binder;
wherein said metallic base component comprises:
i) a metallic aluminum alloy;
ii) a halide activator; and
iii) an inert filler.

2. The homogenous coating paste of claim 1, wherein the metallic aluminum alloy comprises a cobalt group metal.

3. The homogenous coating paste of claim 2, wherein the metallic aluminum alloy is Co₂Al₉.

4. The homogenous coating paste of claim 1, wherein the halide activator is a non-hygroscopic halide activator.

5. The homogenous coating paste of claim 1, wherein the halide activator is ammonium chloride, ammonium iodide, ammonium bromide, ammonium fluoride, ammonium bifluoride, elemental iodine, elemental bromine, hydrogen bromide, aluminum chloride, aluminum fluoride, aluminum bromide, or aluminum iodide.

6. The homogenous coating paste of claim 5, wherein the halide activator is AlF₃.

7. The homogenous coating paste of claim 1, wherein the organic binder comprises methyl cellulose and de-ionized water; hydroxypropylcellulose; a petroleum-based binder; a solvent-based binder; an alcohol-based binder; a water-based organic polymer; or combinations thereof.

8. The homogenous coating paste of claim 7, wherein the organic binder comprises methyl cellulose and de-ionized water.

9. The homogenous paste of claim 1, wherein the inert filler is aluminum oxide (Al₂O₃), kaolin, MgO, SiO₂, Y₂O₃ or Cr₂O₃.

10. The homogenous coating paste of claim 9, wherein the inert filler is Al₂O₃.

11. The homogenous coating paste of claim 1, wherein the ratio of metallic base component to organic binder is from about 10:1 to about 1:10.

12. The homogenous coating paste of claim 11, wherein the ratio of metallic base component to organic binder is from about 5:1 to about 1:5.

13. The homogenous coating paste of claim 12, wherein the ratio of metallic base component to organic binder is from about 2:1 to about 1:2.

14. The homogenous coating paste of claim 1, wherein the ratio of metallic base component to organic binder is about 1:1.

15. The homogenous coating paste of claim 1, wherein the metallic aluminum alloy is from about 1% to about 50% by weight of the total metallic base component.

16. The homogenous coating paste of claim 15, wherein the metallic aluminum alloy is from about 3% to about 40% by weight of the total metallic base component.

17. The homogenous coating paste of claim 16, wherein the metallic aluminum alloy is from about 5% to about 30% by weight of the total metallic base component.

18. The homogenous coating paste of claim 1, wherein the halide activator is from about 0.1% to about 5.0% by weight of the total metallic base component.

19. The homogenous coating paste of claim 18, wherein the halide activator is from about 0.5% to about 4.0% by weight of the total metallic base component.

20. The homogenous coating paste of claim 19, wherein the halide activator is from about 1% to about 3% by weight of the total metallic base component.

21. The homogenous coating paste of claim 1, wherein the metallic aluminum alloy is from about 1% to about 50% by weight of the total metallic base component and the halide activator is from about 0.1% to about 5.0% by weight of the total metallic base component.

22. The homogenous coating paste of claim 21, wherein the metallic aluminum alloy is from about 3% to about 40% by weight of the total metallic base component and the halide activator is from about 0.5% to about 4.0% by weight of the total metallic base component.

23. The homogenous coating paste of claim 22, wherein the metallic aluminum alloy is from about 5% to about 30% by weight of the total metallic base component and the halide activator is from about 1% to about 3% by weight of the total metallic base component.

24. A method of applying a protective coating on the internal surfaces of an article to be coated, said article having at least one internal and at least one external surface and said internal and external surfaces forming at least one internal passage, comprising the steps of:
a) injecting a coating paste into the internal passages of the article;
b) curing the coating paste;
c) heating the article in a furnace within a predetermined temperature range for a sufficient time period to obtain an aluminide coating on the internal surfaces of article; and
d) removing residual paste from the article.

25. The method according to claim 24, wherein the article is a turbine component and the internal passages are the cooling passages of the turbine component.

26. A method according to claim 24, further comprising the step of heat treating the article to produce a desired coating thickness and microstructure.

27. A method according to claim 24, further comprising the step of finishing the article component to obtain a desired surface appearance.

28. A method according to claim 24, further comprising the step of preparing the internal surfaces of article before injecting the paste into the article.

29. A method of applying a protective coating on the external surface of an article to be coated, comprising the steps of:
a) applying a coating paste into the external surface of the article;
b) curing the coating paste;
c) heating the article in a furnace within a predetermined temperature range for a sufficient time period to obtain an aluminide coating on the internal surfaces of article; and
d) removing residual paste from the article.

30. A method according to claim 29, further comprising the step of finishing the article component to obtain a desired surface appearance.

31. A method according to claim 29, further comprising the step of preparing the external surface of article before applying the paste into the article.

32. An apparatus for injecting a coating paste into at least one internal passage of an article to be coated, said article having at least one internal surface and at least one external surface and said internal and external surfaces forming the at least one internal passage, comprising:
a) a fixture for supporting an article having at least one interior passage, the fixture including an inlet portion for receiving coating paste and an outlet portion for delivering coating paste into the cooling passages of a turbine component;
b) a hopper for storing coating paste;
c) a pump assembly including a charging cylinder having a reciprocating piston for accumulating coating paste from the hopper, and for delivering accumulated coating paste to the inlet portion of the fixture; and
d) a control valve in fluid communication with the fixture, the hopper and the pump assembly for controlling the flow of coating paste therebetween.

33. The apparatus for injecting coating paste according to claim 32, wherein the article is a turbine component and the internal passage is a cooling passage of the turbine component.

34. The apparatus for injecting coating paste according to claim 32, further comprising a mixing unit in fluid communication with the hopper to provide mixing of the coating paste in the hopper.

35. The apparatus for injecting coating paste according to claim 34, wherein the mixing unit is capable of providing continuous mixing of the coating paste in the hopper during injection.
